(19) United States
(12) Patent Application Publication
(10) Pub. No.: US 2025/0029382 A1
(43) Pub. Date: Jan. 23, 2025

(54) EVENT DETECTING APPARATUS, EVENT DETECTING METHOD, AND STORAGE MEDIUM

(71) Applicants: NEC CORPORATION, Tokyo (JP); National Universoreity of Singapore, Singapore (SG)

(72) Inventors: Satoshi YAMAZAKI, Tokyo (JP); Karen Stephen, Tokyo (JP); Jianquan Liu, Tokyo (JP); Rishabh Sheoran, Singapore (SG); Yong Kang Wong, Singapore (SG); Mohan Kankanhalli, Singapore (SG)

(73) Assignees: NEC CORPORATION, Tokyo (JP); National Universoreity of Singapore, Singapore (SG)

(21) Appl. No.: 18/777,784

(22) Filed: Jul. 19, 2024

(30) Foreign Application Priority Data
Jul. 20, 2023 (SG) 10202302052W

(51) Int. Cl. G06V 20/40; G06V 10/74; G06V 20/52; G06V 40/20

(52) U.S. Cl. CPC G06V 20/44; G06V 10/761; G06V 20/52; G06V 40/20

(57) ABSTRACT

An event detecting apparatus acquires one or more video data, and generates, from the one or more video data, object relationship information that indicates two or more action-related relationships between objects. The event detecting apparatus acquires an event information that indicates an event of interest by a sequence of action-related situations at least one of which represents a situation in which a specific action is taken by a specific subject. The event detecting apparatus determines whether or not the event of interest occurs based on the object relationship information and the event information.

### INCORPORATION BY REFERENCE

This application is based upon and claims the benefit of priority from Singaporean patent application Ser. No. 10/202,302052W, filed on Jul. 20, 2023, the disclosure of which is incorporated herein in its entirety by reference.

### TECHNICAL FIELD

The present disclosure generally relates to event detecting apparatus, event detecting method, and storage medium.

### BACKGROUND ART

There are techniques to use a video data to monitor objects. Japanese Unexamined Patent Application Publication No. 2009-075802 discloses a technique to detect the center of mass of a person from each one of video frames and recognizes behaviors of that person based on a trajectory of the center of mass of that person.

### SUMMARY

Information that can be used to monitor objects based on a video data is not limited to the centers of mass of those objects. An example objective of this disclosure is to provide a novel technique to monitor objects based on a video data on which those objects are captured.

In a first example aspect, an event detecting apparatus comprising: at least one memory that is configured to store instructions; and at least one processor.

The at least one processor is configured to execute the instructions to:

acquire one or more video data; generate, from the one or more video data, object relationship information that indicates two or more action-related relationships between objects; acquire an event information that indicates an event of interest by a sequence of action-related situations at least one of which represents a situation in which a specific action is taken by a specific subject; and determine whether or not the event of interest occurs based on the object relationship information and the event information.

In a second example aspect, an event detecting method comprising: acquiring one or more video data; generating, from the one or more video data, object relationship information that indicates two or more action-related relationships between objects; acquiring an event information that indicates an event of interest by a sequence of action-related situations at least one of which represents a situation in which a specific action is taken by a specific subject; and determining whether or not the event of interest occurs based on the object relationship information and the event information.

In a third example aspect, a storage medium storing a program that causes a computer to execute: acquiring one or more video data; generating, from the one or more video data, object relationship information that indicates two or more action-related relationships between objects; acquiring an event information that indicates an event of interest by a sequence of action-related situations at least one of which represents a situation in which a specific action is taken by a specific subject; and determining whether or not the event of interest occurs based on the object relationship information and the event information.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 illustrates an overview of an event detecting apparatus;

FIG. 2 is a block diagram illustrating an example of the functional configuration of the event detecting apparatus;

FIG. 3 is a block diagram illustrating an example of the hardware configuration of a computer 1000 realizing the event detecting apparatus;

FIG. 4 is a flowchart illustrating an example flow of processing performed by the event detecting apparatus;

FIG. 5 illustrates the object relationship information in a table format;

FIG. 6 illustrates the object information in a table format;

FIG. 7 illustrates an example of the scene graph;

FIG. 8 is a flowchart illustrating a flow of processing performed by the generating unit;

FIG. 9 illustrates the event information in a table format;

FIG. 10 illustrates the event information that indicates the duration for each situation;

FIG. 11 illustrates the event information that indicates a lack of a specific action; and

FIG. 12 is a flowchart illustrating an example flow of processing that is performed by the determining unit;

### EXAMPLE EMBODIMENT

Hereinafter, example embodiments of the present disclosure are described in detail with reference to the drawings. In the drawings, the same or corresponding element is denoted by the same reference sign, and redundant descriptions are omitted as necessary for clarity of description. Unless otherwise stated, predetermined information (e.g., a predetermined value or a predetermined threshold) is stored in advance in a storage device to which a computer using that information has access unless otherwise described. Further, unless otherwise stated, a storage unit is constituted by one or more storage devices.

### Overview

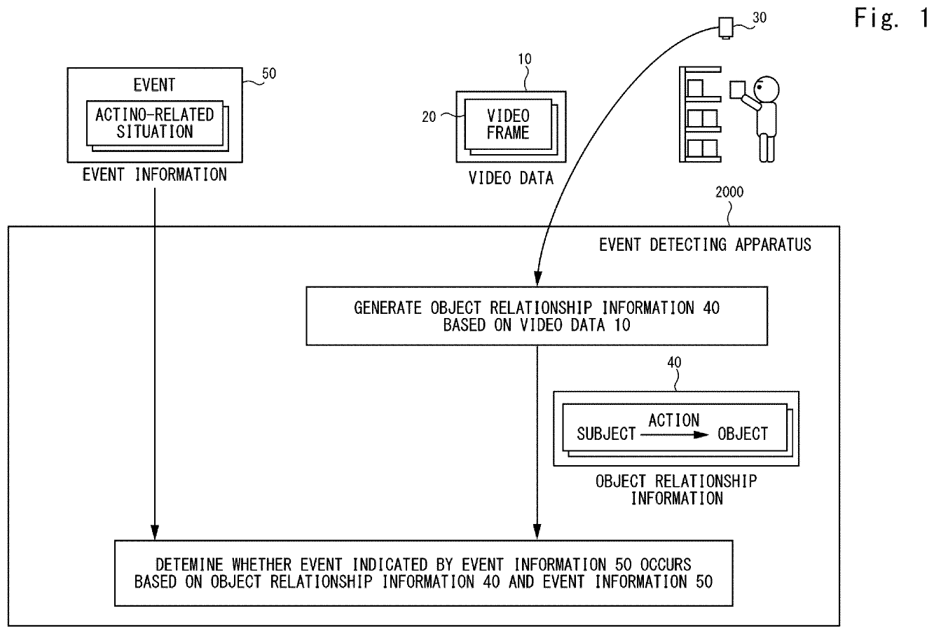

FIG. 1 illustrates an overview of an event detecting apparatus 2000. It is noted that the overview illustrated by FIG. 1 shows an example of operations of the event detecting apparatus 2000 to make it easy to understand the event detecting apparatus 2000, and does not limit or narrow the scope of possible operations of the event detecting apparatus 2000.

The event detecting apparatus 2000 is used to detect an action-related event from one or more video data 10. The video data 10 is a sequence of video frames 20, which are generated by a camera 30. In some situations, two or more cameras 30 are used to generated two or more video data 10.

The action-related event is any type of event that can be defined by two or more action-related situations each of which represents a situation in which a specific action is taken by a specific subject or a situation in which a specific action is not taken by a specific subject. Examples of the action-related event include Purchasing, Shoplifting, Bicycle theft, Baggage theft, Loitering, Stalking, and Left baggage.

The action-related situations that define the action-related event includes at least one situation in which a specific action is taken by a specific subject. The subject of the action may include any kinds of object that can take an action: e.g., a human, an animal (e.g., dog or cat), a vehicle (e.g., car, bicycle, or aircraft), and a robot.

For example, the action-related event “Purchasing” can be defined by the following three action-related situations:
1. a person picks up a store item.
2. That person stands in front of a cashier for a while.
3. That person goes through an exit.

To detect a specific action-related event from the video data 10, the event detecting apparatus 2000 may operate as follows. The event detecting apparatus 2000 acquires the video data 10, and generates object relationship information 40. The object relationship information 40 represents two or more temporal action-related relationships between objects, each of which is an action-related relationship between objects that exists at a certain time or during a certain period of time.

Specifically, the object relationship information 40 may include two or more combinations of 1) a type of action, 2) a subject of the action, 3) an object of the action, and 4) time when the action is taken. Suppose that there is a relationship in which a person P1 picks up a store item I1 from time T1 to T2. The object relationship information 40 may represent this relationship by a combination of 1) Type of action: Pick up, 2) Subject: Person P1, 3) Object: Store Item I1, and 4) Time: T1 to T2.

The event detecting apparatus 2000 also acquires an event information 50, which represents an action-related event to be detected by a sequence of action-related situations. Hereinafter, an event to be detected is also called “event of interest”. Suppose that the action-related event of interest is “Purchasing”, which is explained above. In this case, the event information 50 may indicate the sequence of the three action-related situations mentioned above.

The event detecting apparatus 2000 determines whether or not the event indicated by the event information 50 occurs based on the object relationship information 40. Specifically, the event detecting apparatus 2000 determines whether or not the object relationship information 40 includes a sequence of action-related relationships between objects that matches the sequence of the action-related situations indicated by the event information 50.

When the object relationship information 40 includes a sequence of action-related relationships between objects that matches the sequence of the action-related situations indicated by the event information 50, the event detecting apparatus 2000 determines that the action-related event indicated by the event information 50 occurs. On the other hand, when the object relationship information 40 does not include a sequence of action-related relationships between objects that matches the sequence of the action-related situations indicated by the event information 50, the event detecting apparatus 2000 determines that the action-related event indicated by the event information 50 does not occur.

### Example of Advantageous Effect

As described above, the event detecting apparatus 2000 uses the video data 10 to generate the object relationship information 40, which indicates one or more temporal action-related relationships between objects. In addition, the event detecting apparatus 2000 acquires the event information 50, which indicates an action-related event by a sequence of action-related situations. Then, the event detecting apparatus 2000 determines whether or not the action-related event indicated by the event information 50 occurs based on the object relationship information 40 and the event information 50. According to the event detecting apparatus 2000, a novel technique to monitor objects based on a video data on which those objects are captured is provided. More specifically, a novel technique to detect an event related to actions of objects from a video data on which those objects are captured is provided.

Furthermore, PTL1 focuses on the movement of merely a single object, and does not disclose a technique to detect an action-related event in which two or more objects have some relationships. On the other hand, the event detecting apparatus 2000 detects action-related relationships between objects from the video data 10, and thus can detect an action-related event that involves some relationships between objects. Therefore, the event detecting apparatus 2000 can detect more complex events than the events that are defined by the movement of a single object.

Hereinafter, more detailed explanation of the event detecting apparatus 2000 will be described.

### Example of Functional Configuration

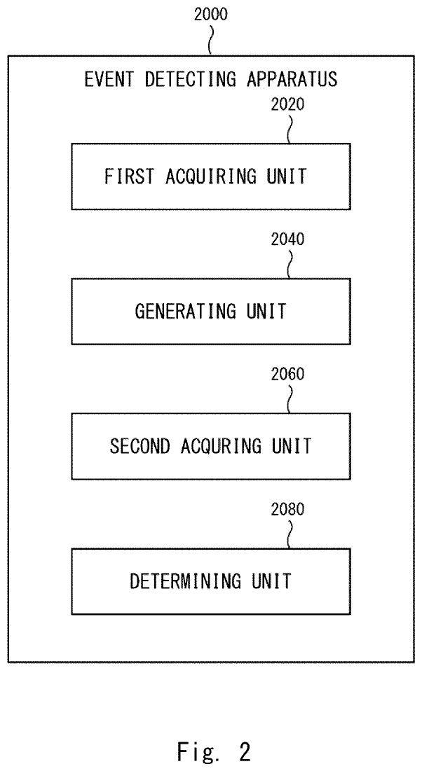

FIG. 2 is a block diagram illustrating an example of the functional configuration of the event detecting apparatus 2000. The event detecting apparatus 2000 includes a first acquiring unit 2020, a generating unit 2040, a second acquiring unit 2060, and a determining unit 2080. The first acquiring unit 2020 acquires the video data 10. The generating unit 2040 generates the object relationship information 40 from the video data 10. The second acquiring unit 2060 acquires the event information 50. The determining unit 2080 determines whether or not the action-related event indicated by the event information 50 occurs based on the object relationship information 40.

### Example of Hardware Configuration

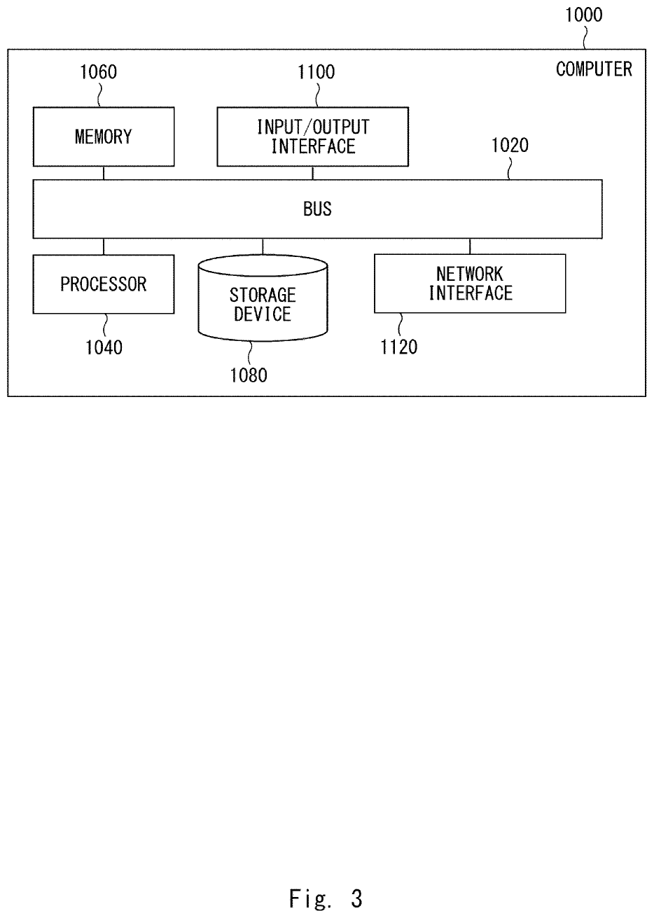

The event detecting apparatus 2000 may be realized by one or more computers. FIG. 3 is a block diagram illustrating an example of the hardware configuration of a computer 1000 realizing the event detecting apparatus 2000. The computer 1000 may be any type of computer. For example, the computer 1000 is a stationary computer, such as a personal computer (PC) and a server machine. In another example, the computer 1000 is a mobile computer, such as a smartphone and a table terminal. In another example, the computer 1000 is an integrated circuit, such as a SoC (system on chip). The computer 1000 may be a special-purpose computer manufactured for implementing the event detecting apparatus 2000 or may be a general-purpose computer.

The event detecting apparatus 2000 may be realized by installing an application in the computer 1000. The application is implemented with a program that causes the computer 1000 to function as the event detecting apparatus 2000. In other words, the program is an implementation of the functional units of the event detecting apparatus 2000.

There are various ways to acquire the program. For example, the program may be acquired from a storage medium (e.g., a DVD disk or a USB memory) in which the program is stored. In another example, the program may be downloaded from a server that manages a storage medium storing the program.

In FIG. 3, the computer 1000 includes a bus 1020, a processor 1040, a memory 1060, a storage device 1080, an input/output (I/O) interface 1100, and a network interface 1120. The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The processor 1040 may be configured to load instructions of the above-mentioned program from the storage device 1080 into the memory 1060 and execute those instructions, so as to cause the computer 1000 to operate as the event detecting apparatus 2000.

The hardware configuration of the computer 1000 is not restricted to that shown by FIG. 3. For example, as mentioned-above, the event detecting apparatus 2000 may be realized as a combination of multiple computers. In this case, those computers may be connected with each other through the network.

In some embodiments, the event detecting apparatus 2000 may be realized with two computers; the first computer operates as the first acquiring unit 2020 and the generating unit 2040 to generate the object relationship information 40 from the video data 10, while the second computer operates as the second acquiring unit 2060 and the determining unit 2080 to determine whether or not the action-related event indicated by the event information 50 occurs based on the object relationship information 40.

In this case, the event detecting apparatus 2000 can also be seen as an event detecting system comprising a generating apparatus and a detecting apparatus. The generating apparatus includes the first acquiring unit 2020 and the generating unit 2040. The detecting apparatus includes the second acquiring unit 2060 and the determining unit 2080.

### Flow of Process

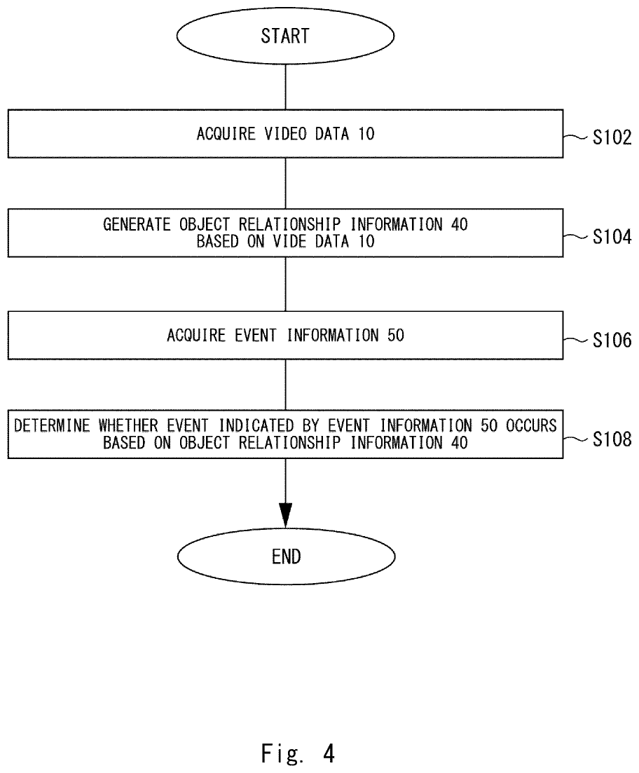

FIG. 4 is a flowchart illustrating an example flow of processing performed by the event detecting apparatus 2000. The first acquiring unit 2020 acquires the video data 10 (S102). The generating unit 2040 generates the object relationship information 40 from the video data 10 (S104). The second acquiring unit 2060 acquires the event information 50 (S106). The determining unit 2080 determines whether or not the action-related event indicated by the event information 50 based on the object relationship information 40 (S108).

### Acquisition of Video Data 10: S102

The first acquiring unit 2020 acquires the video data 10 (S102). There are various ways to acquire the video data 10. For example, the camera 30 is configured to send the video data 10 to the event detecting apparatus 2000. In this case, the first acquiring unit 2020 receives the video data 10 sent by the camera 30 to acquire the video data 10.

In another example, the camera 30 is configured to, when it generates a video frame 20, send this video frame 20 to the event detecting apparatus 2000. In this case, the first acquiring unit 2020 receives the video frames 20 sent by the camera 30 to generate the video data 10 from the received video frames 20. In another example, the camera 30 is configured to put the video data 10 into a storage unit to which the event detecting apparatus 2000 has access. In this case, the event detecting apparatus 2000 acquires the video data 10 from this storage unit.

### As to Object Relationship Information 40

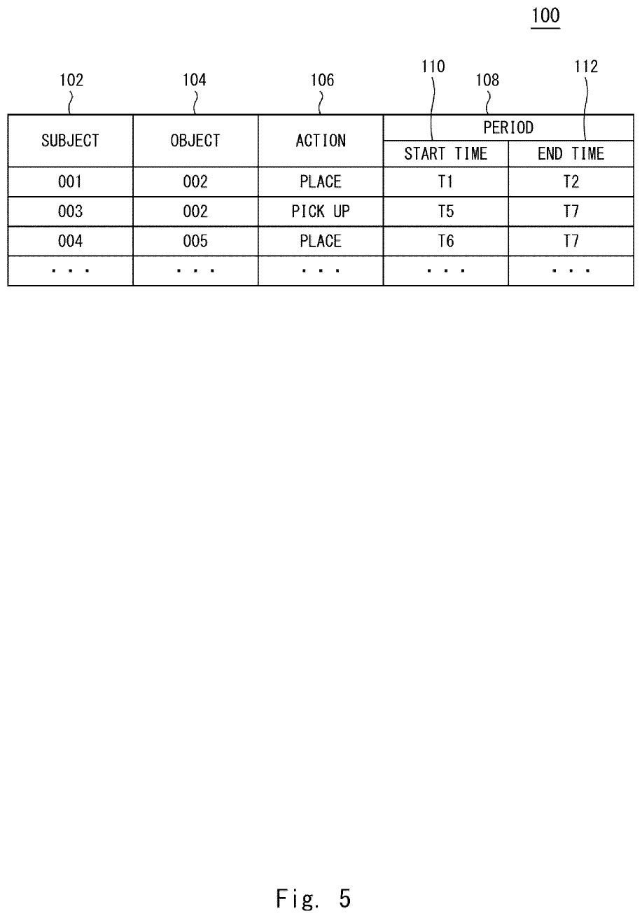

As mentioned above, the object relationship information 40 represents two or more action-related relationships between objects with respect to an action. FIG. 5 illustrates the object relationship information 40 in a table format. In FIG. 5, the object relationship information 40 is represented by a table 100. The table 100 has columns named “subject 102”, object 104”, “action 106”, and “period 108”. The action 106 indicates a type of action. The subject 102 indicates an identifier of an object that takes the corresponding action. The object 104 indicates an identifier of an object toward which the corresponding subject takes the corresponding action. The period 108 indicates from when to when the corresponding action-related relationship exists. Specifically, the period 108 is comprised of the two columns named “start time 110” and “end time 112”. The start time 110 indicates time at which the corresponding action-related relationship starts. The end time 112 indicates time at which the corresponding action-related relationship ends.

The subject 102 and the object 104 are represented by an identifier of the object. The identifier of each object may be defined by another piece of information, called “object information”, which is also generated from the video data 10 by the event detecting apparatus 2000. The object information may indicate, for each one of the objects detected from the video data 10, an identifier of the object and a type of the object (e.g., person, store item, bag, etc.). In the video data 10, the position of each object may be changed. Thus, it is preferable that the object information indicates pair of time and position for each object. In other words, the object information indicates a time series of the positions for each object.

There are various ways to represent a position of the object. For example, the position of the object may be represented by coordinates on the video frame 20 at which the object is located. When the event detecting apparatus 2000 handles two or more video data 20, the position of the object may be represented by a pair of a camera identifier and the coordinates on the video frame 20 at which the object is located.

In another example, the position of the object may be represented by coordinates on a map of an area that is captured by one or more cameras 30. The map may be a two-dimensional map or a three-dimensional map.

In this case, the generating unit 2040 converts the coordinates on the video frame 20 at which the object is located into coordinates on the map. By using the map, the positions of objects that are captured by different cameras 30 from each other can be represented by coordinates on a unified coordinate space. In addition, using the map enables the event detecting apparatus 2000 to handle the camera 30 capable of changing its field of view (e.g., a pan-tilt-zoom camera).

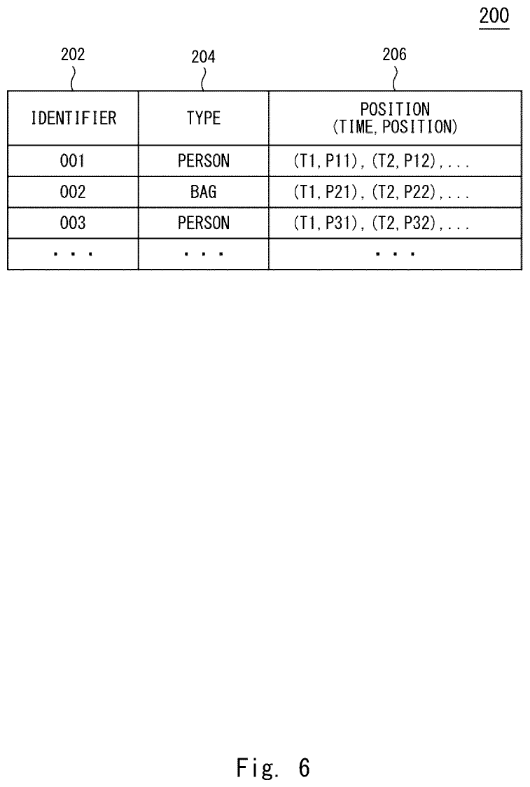

FIG. 6 illustrates the object information in a table format. In FIG. 6, the object information is represented by a table 200. The table 200 includes columns named “identifier 202”, “type 204”, and “position 206”. The identifier 202 indicates an identifier that is assigned to the corresponding object. The type 204 indicates a type of the corresponding object. The position 206 indicates a sequence of pairs of the time and the position for the corresponding object.

The action-related relationships between objects at a moment can also be represented by a scene graph, which represents each object by a node and the action-related relationship between objects by an edge. It can be said that the object relationship information 40 represents a sequence of scene graphs. Thus, the event detecting apparatus 2000 can be used to search a sequence of scene graphs for an action-related event.

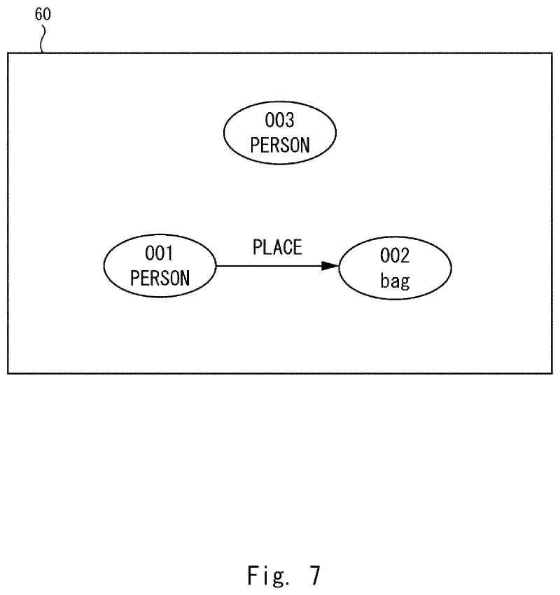

FIG. 7 illustrates an example of the scene graph. In the example shown by FIG. 7, three objects are detected: a person to which an identifier 001 is assigned; a bag to which an identifier 002 is assigned; and another person to which an identifier 003 is assigned. Thus, the scene graph 60 includes three nodes that represent the person 001, the bag 002, and the person 003, respectively.

The person 001 and the bag 002 are connected with each other by an edge that is tagged with “place” and that is directed from the person 001 to the bag 002. This action-related relationship represents that the person 001 places the bag 002. The person 003 is connected with nothing. This means that the person 003 takes no action.

### Generation of Object Relationship Information 40: S104

The generating unit 2040 generates the object relationship information 40 from the video data 10. For example, for each one of the video frames 20 included in the video data 10, the generating unit 2040 performs object detection to generate the object information and then detects action-related relationships for the objects detected through the object detection.

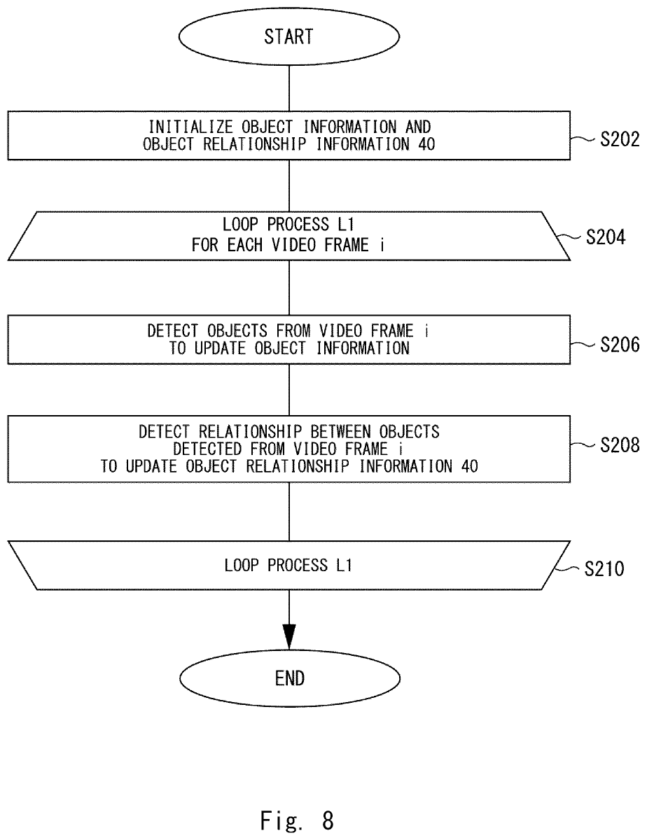

FIG. 8 is a flowchart illustrating a flow of processing performed by the generating unit 2040. The generating unit 2040 initializes the object information and the object relationship information 40.

Steps S204 to S210 constitute a loop process L1, which is performed for each video frame 20 included in the video data 10. At Step S204, the generating unit 2040 determines whether or not the loop process L1 has been performed for all the video frames 20. When the loop process L1 has been performed for all the video frames 20, the loop process L1 is terminated.

When the loop process LL1 1 has not been performed for all the video frames 20, the generating unit 2040 selects the video frame 20 for which the loop process L1 is to be performed next. The video frame 20 selected here is the video frame 20 with the earliest time of generation (e.g., with the smallest frame number) of the video frames 20 for which the loop process L1 is not performed yet. The video frame 20 selected here is called “video frame i”.

The generating unit 2040 performs object detection on the video frame i to detect objects from the video frame i, and update the object information (S206). When an object detected from the video frame i has not been detected from the preceding video frames 20, the generating unit 2040 assigns a new identifier to this object and adds a new record with respect to this object into the object information. When an object detected from the video frame i has been detected from the preceding video frames 20, the generating unit 2040 updates the record of this object in the object information by adding a pair of time and position of this object to the record. The time of this pair represents the time when the video frame i is generated. The position of this pair represents the position of the object on the video frame i.

The generating unit 2040 performs detection of action-related relationships between objects detected from the video frame i to update the object relationship information 40 (S208). When an action-related relationship between particular objects that is detected from the video frame i is also detected from the video frame (i-1), the generating unit 2040 updates the record of this action-related relationship in the object relationship information 40 to increase the duration of this relationship. On the other hand, when an action-related relationship between particular objects that is detected from the video framed i is not detected from the video frame (i-1), the generating unit 2040 generates a new record with respect to this relationship and adds this record to the object relationship information 40.

Step 210 is the end of the loop process L1. Thus, the generating unit 2040 performs Step S204 next.

### As to Event Information 50

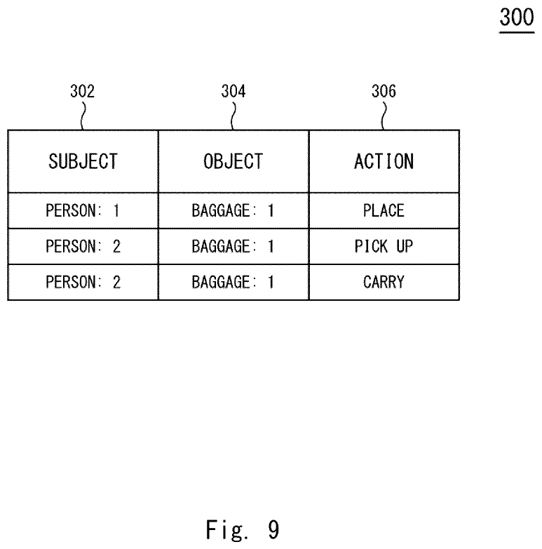

The event information 50 indicates a sequence of action-related situations that represents an action-related event of interest. FIG. 9 illustrates the event information 50 in a table format. In FIG. 9, the event information 50 is represented by a table 300. The table 300 has columns named “subject 302”, “object 304”, and “action 306”

The action 306 indicates a type of action. The subject 302 indicates a type of an object that takes the corresponding action. The object 304 indicates a type of an object toward which the corresponding subject takes the corresponding action.

It is noted that, there may be cases where the event information 50 needs to indicate different objects that belong to the same type as each other. Thus, the subject 302 and the object 304 need to indicate objects of the same type in a distinguishable manner.

For example, the table 300 shown by FIG. 9 indicates an event “Baggage Theft”. Baggage Theft includes a victim who is an owner of baggage and a criminal who steals the baggage. The first row represents an action-related situation in which a victim places baggage. To represent this situation, the subject 302, the object 304, and the action 306 of the first row indicate “PERSON: 1”, “BAGGAGE: 1”, and “PLACE”, respectively. The value “PERSON: 1” represents a first person involved in this event. The value “BAGGAGE: 1” represents first baggage involved in this evet.

The second row represents a situation in which a criminal picks up the baggage. To represent this situation, the subject 302, the object 304, and the action 306 indicate “PERSON: 2”, “BAGGAGE: 1”, and “PICK UP”, respectively. The value “PERSON: 2” represents a second person involved in this event who is any person other than the first person “PERSON: 1”. The value “BAGGAGE: 1” represents the first baggage, which is the same as that indicated by the first row.

The third row represents an action-related situation in which a criminal carries the baggage away. To represent this situation, the subject 302, the object 304, and the action 306 of the third row indicate “PERSON: 2”, “BAGGAGE: 1”, and “CARRY”, respectively. The value “PERSON: 2” represents the second person who is the same as that indicated by the second row. The value “BAGGAGE: 1” represents the first baggage which is the same as that indicated by the first and the second row.

The table 300 may include further information. For example, the table 300 may include another column named “duration”, which indicates a minimum length of time during which the corresponding situation continues.

Suppose that the last situation of Baggage Theft represented by the third row of the table 300 shown by FIG. 9 continues only for one second. This means that the second person carries the baggage merely a few meters away from the place where the first person places the baggage. In this case, the second person may not intend to steal the baggage.

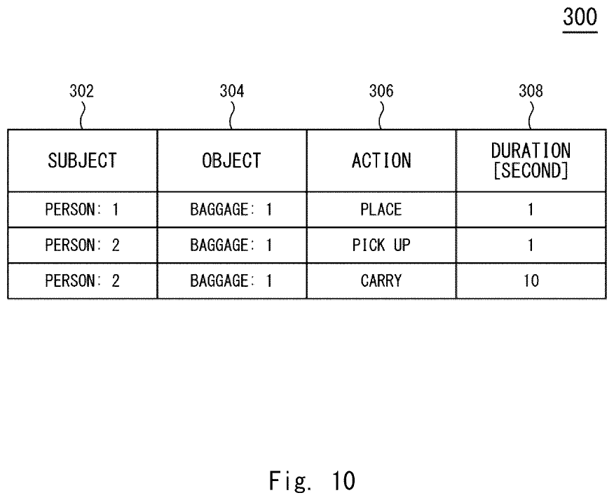

The column “duration” may be used to avoid this kind of false detection. FIG. 10 illustrates the event information 50 that indicates the duration for each situation. In FIG. 10, the table 300 further includes a column named “duration 308”, which indicates the duration of the corresponding action kept taken.

The duration 308 of the third row of the table 300 in FIG. 10 indicates 10 seconds. This means that the second person carries the baggage for at least 10 seconds, thereby carrying the baggage substantially away from the place where the first person placed the baggage. In this case, it is highly possible that the second person intends to steal the baggage.

In another example, the event information 50 may indicate a lack of a specific action. An example of action-related events that can be defined with a lack of a specific action is “Shoplifting”. Shoplifting can be defined as follows.
1. a person picks up a store item.
2. That person DOES NOT stand in front of a cashier for a while.
3. That person goes through an exit.

When a person shoplifts a store item, the person does not stand in front of a cashier since the person does not pay for the store item. Thus, Shoplifting lacks an action of the person standing in front of the cashier for a while. The second item of the above list of Shoplifting represents that an action “that person stands in front of a cashier for a while” is lacked.

To enable the event information 50 to represent an action-related situation in which a specific action is lacked, the table 300 may include “lack flag”. The lack flag represents whether or not the corresponding action is taken. Specifically, the lack flag indicating “true” represents that the corresponding action is not taken (i.e., the corresponding action is lacked). On the other hand, the lack flag indicating “false” represents that the corresponding action is taken (i.e., the corresponding action is not lacked). Hereinafter, an action-related situation in which a specific action is not taken is also called “lack situation”.

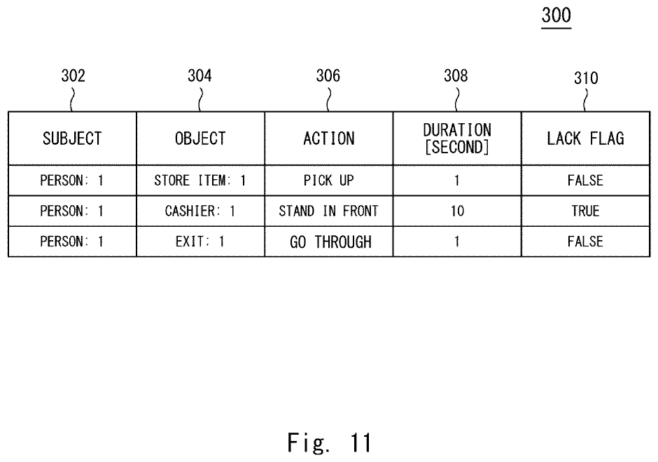

FIG. 11 illustrates the event information 50 that indicates a lack of a specific action. The table 300 shown by FIG. 11 further includes a column named “lack flag 310”.

The table 300 shown by FIG. 11 represents an event “Shoplifting”. Specifically, the first row of the table 300 shown by FIG. 11 represents a situation in which a first person picks up a first store item. To represent this situation, the subject 302, the object 304, the action 306, the duration 308, and the lack flag 310 indicate “PERSON: 1”, “STORE ITEM: 1”, “PICK UP”, “1 SECOND”, and “FALSE”, respectively. Since the action of picking up is taken, the lack flag 310 indicates “FALSE”: i.e., the corresponding action is NOT lacked.

The second row of the table 300 shown by FIG. 11 represents a situation in which the first person DOES NOT stand in front of a cashier for at least 10 seconds. To represent this situation, the subject 302, the object 304, the action 306, the duration 308, and the lack flag 310 indicate “PERSON: 1”, “CASHIER: 1”, “STAND IN FRONT”, “10 SECONDS”, and “TRUE”, respectively. Since the action of standing in front of a cashier is NOT taken, the lack flag 310 indicates “TRUE”: i.e., the corresponding action IS lacked.

The third row of the table 300 shown by FIG. 11 represents a situation in which the first person goes through an exit for at least 1 seconds”. To represent this situation, the subject 302, the object 304, the action 306, the duration 308, and the lack flag 310 indicate “PERSON: 1”, “EXIT: 1”, “GO THROUGH”, “1 SECONDS”, and “FALSE”, respectively. Since the action of going through an exit is taken, the lack flag 310 indicates “FALSE”: i.e., the corresponding action is NOT lacked.

### Acquisition of Event Information 50: S106

The second acquiring unit 2060 acquires the event information 50 (S106). In some embodiments, the second acquiring unit 2060 receives a query aimed at detecting a specific event from the video data 10. In this case, the query includes the event information 50 that indicates the action-related event of interest. The query may be sent by a user device that is used by a user of the event detecting apparatus 2000.

In some embodiments, one or more action-related events of interest are specified in advance. In this case, for each one of the events of interest, the event information 50 representing the event of interest is stored in advance in a storage unit to which the event detecting apparatus 2000 has access. In this case, the second acquiring unit 2060 acquirers one or more pieces of the event information 50 from the storage unit. Then, for each event information 50, the determining unit 2080 performs detection of the event of interest represented by the event information 50.

### Detection of Event: S108

The determining unit 2080 determines whether or not the action-related event of interest occurs based on the object relationship information 40 and the event information 50 (S108). To do so, the determining unit 2080 determines whether or not the object relationship information 40 includes a sequence of the action-related relationships that matches the sequence of the action-related situations indicated by the event information 50.

Hereinafter, for the sake of clarity, it is first assumed that the event information 50 does not include action-related situations in which a specific action is not taken.

Suppose that the object relationship information 40 includes a sequence of twenty relationships, which is denoted by R[]={R[1], R[2], . . . , R[20]}, whereas the event information 50 includes a sequence of three situations, which is denoted by S[]={S[1], S[2], S[3]}. In this case, when R[] includes R[i] matching S[1], R[j] matching S[2], and R[k] matching S[3] and i<j<k is satisfied, the determining unit 2080 determines that the object relationship information 40 includes a sequence {R[i], R[j], R[k]} that matches the sequence {S[1], S[2], S[3]} indicated by the event information 50. Thus, in this case, the determining unit 2080 determines that the action-related event of interest occurs.

Hereinafter, the sequence of the action-related relationships indicated by the object relationship information 40 is denoted by R[]={R[1], . . . , R[Nr]}. In addition, the sequence of the action-related situations indicated by the event information 50 is denoted by S[]={S[1], . . . , S[Ns]}. It is noted that both Nr and Ns are integers larger than 1.

Overall, the determining unit 2080 tries to detect each one of the action-related situations {S[1], . . . , S[Ns]} from the action-related relationships {R[1], . . . , R[Nr]} in turn. First, the determining unit 2080 searches the first situation S[1] for {R[1], . . . , R[Nr]}, thereby detecting R[i] as the relationship that matches S[1]. Next, the determining unit 2080 searches the second situation S[2] for a partial sequence {R[i+1], . . . , R[Nr]}, thereby detecting R[j] as the relationship that matches S[2]. Then, the determining unit 2080 searches the third situation S[3] for a partial sequence {R[j+1], . . . , R[Nr]}, thereby detecting R [k] as the relationships that matches S[3]. This processing is performed repeatedly until the determining unit 2080 successfully finds a corresponding action-related relationship for the last situation S [Ns] or the determining unit 2080 fails to find an action-related relationship for any one of the situations.

In some cases, the object relationship information 40 includes two or more action-related relationships that match the situation S[a](1<=a<Ns). In this case, for each one of the action-related relationships that match S[a], the determining unit 2080 performs succeeding search for an action-relate relationship matching the situation S[a+1].

Suppose that: the object relationship information 40 includes {R[1], . . . , R[20]}; the event information 50 includes {S[1], S[2]}; R[3] and R[10] match S[1]; and R[5] matches S[2]. In this case, first, the determining unit 2080 searches {R[1], . . . , R[20]} for a relationship matching S[1], thereby detecting R[3] and R[10]. Then, the determining unit 2080 searches {R[4], . . . , R[20]} for a relationship matching S[2], thereby detecting R[5]. In addition, the determining unit 2080 searches {R[11], . . . , R[20]} for a relationship matching S[2], thereby detecting nothing. As a result, the determining unit 2080 determines that the object relationship information 40 includes a sequence {R[3], R[5]} that matches the sequence {S[1], S[2]}.

To determine whether or not an action-related relationship matches an action-related situation, the determining unit 2080 compares their corresponding elements with each other. For example, the determining unit 2080 determines whether or not the subject 102 of the action-related relationship matches the subject 302 of the action-related situation, whether or not the object 104 of the action-related relationship matches the object 304 of the action-related situation, whether or not the action 106 of the action-related relationship matches the action 306 of the action-related situation, and whether or not the length of the period 108 of the action-related relationship matches the duration 308 of the action-related situation.

When the subject 102, the object 104, the action 106, and the length of the period 108 of the action-related relationship respectively match the subject 302, the object 304, the action 306, and the duration 308, the determining unit 2080 determines that the action-related relationship matches the action-related situation. On the other hand, when the subject 102 does not match the subject 302, when the object 104 does not match the object 304, when the action 106 does not match the action 306, or the length of the period 108 does not match the duration 308, the determining unit 2080 determines that the action-related relationship matches the action-related situation.

The determination of whether or not an action-related relationship matches an action-related situation is performed under restrictions generated by the preceding matchings. When matching is performed for the first situation, there is no restriction yet. Thus, the subject 102 and the subject 302 are determined to match each other when their types are same as each other. Similarly, the object 104 and the object 304 are determined to match each other when their types are same as each other.

Suppose that the first action-related situation S[1] represents that “Person 1 picks up Store item 1”. In addition, an action-related relationship R[i] representing “Object 003 whose type is Person picks up Object 007 whose type is Store item”. In this example, the determining unit 2080 determines that R[i] matches S[1]. Then, the determination unit 2080 generates restrictions “Person 1 is Object 003”, “Persons other than Person 1 are not Object 003”, “Store item 1 is Object 007”, and “Store items other than Store item 1 are not Object 007”.

In succeeding matchings for the situations {S[2], . . . , S[Ns]}, the determining unit 2080 performs the matching taking these restrictions into consideration. For example, the subject 102 is determined to match the subject 302 indicating “Person 1” only when the subject 102 indicates “Object 003”. In addition, the subject 102 is determined to match the subject 302 indicating a person other than person 1 (e.g., Person 2) only when the subject 102 indicates an object whose type is Person and that is not Object 003.

The determining unit 2080 cumulatively generates the restrictions. For example, after the matching for the situation S[2], the determining unit 2080 generates additional restrictions based on the matching for the situation S[2]. Then, the determining unit 2080 performs the matching for the situation S[3] taking both the restrictions generated based on the matching for the situation S[1] and the restrictions generated based on the matching for the situation S[2] into consideration.

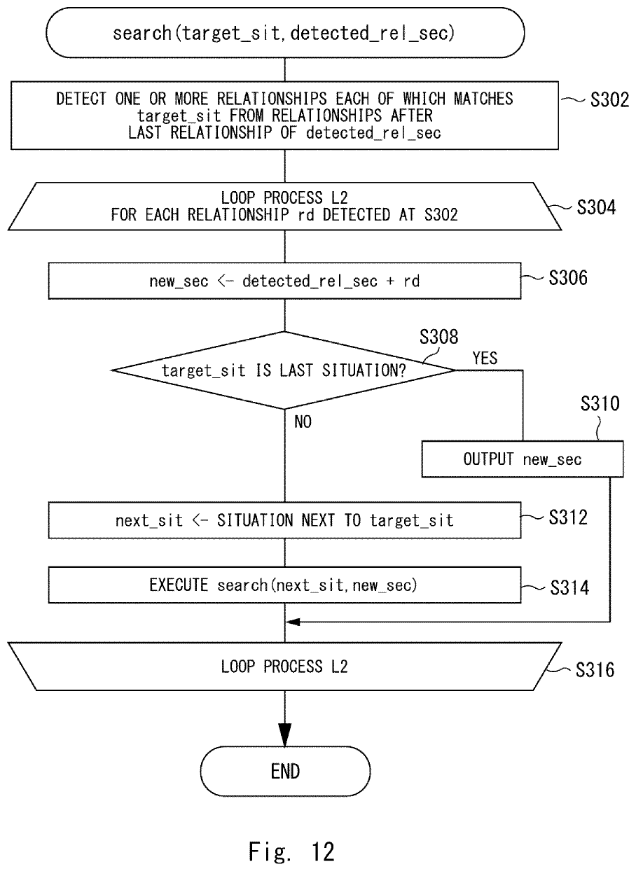

FIG. 12 is a flowchart illustrating an example flow of processing that is performed by the determining unit 2080. Specifically, FIG. 12 shows a flow of a recursive procedure named “search(). The procedure search() takes two arguments: target_sit represents an action-related situation that is a target of the search; and detected_rel_sec represents a sequence of the action-related relationships that is determined to match a sequence of the action-related situations before target_sit.

The determining unit 2080 first executes search() with target_sit being the first situation S[1] and detected_rel_sec being empty. At Step S302, the determining unit 2080 detects one or more action-related relationships each of which matches target_sit from the sequence of relationships after the last relationship indicated by detecte_rel_sec. Suppose that detected_rel_sec includes {R[3], R[5]}. In this case, the determining unit 2080 searches {R[6], . . . , R[Nr]} for target_sit. It is noted that the determining unit 2080 searches a whole sequence {R[1], . . . , R[Nr]} for target_sit when detected_rel_sec is empty.

Steps S304 to S316 constitutes a loop process L2, which is performed for each one of the action-related relationships detected at S302. At Step S304, the determining unit 2080 determines whether or not the loop process L2 has been performed for all the action-related relationships detected at Step S302. When the loop process L2 has been performed for all the action-related relationships detected at Step S302, the current execution of the procedure search() ends. On the other hand, when there is at least one of the action-related relationships detected at Step S302 for which the loop process L2 is not performed yet, the determining unit 2080 selects one of the action-related relationships detected at Step S302 for which the loop process L2 is not performed yet. The action-related relationship selected here is denoted by rd. It is noted that the determining unit 2080 does not perform the loop process L2 when no action-related relationship is detected at S302.

At Step S306, the determining unit 2080 defines a new sequence named “new_sec” by adding the relationship rd to detected_rel_sec. The sequence new_sec represents one of the sequences of the action-related relationships that match a sequence of the action-related situations that is from the first situation to target_sit.

Then, the determining unit 2080 determines whether or not target_sit is the action-related situation at the last of the sequence indicated by the event information 50 (S308). When target_sit is the action-related situation at the last of the sequence indicated by the event information 50, the determining unit 2080 outputs new_sec as a sequence of the action-related relationships that matches a whole of the sequence of the action-related situations indicated by the event information 50.

On the other hand, when target_sit is not the action-related situation at the last of the sequence indicated by the event information 50, the determining unit 2080 performs succeeding matching for the action-related situation next to target_sit. To do so, the determining unit 2080 defines a variable “next sit” that represents the action-related situation that is at next to target_sit in the event information 50 (S312). Then, the determining unit 2080 recursively executes the procedure search() with next_sit being set to the first argument target_sit and new_sec being set to the second argument detected_rel_sec (S314).

Step S316 is the end of the loop process L2. Thus, when the determining unit 2080 reaches Step S316, the determining unit 2080 performs Step S304 next.

Hereinafter, how to handle the event information 50 that includes one or more lack situations. In this case, the determining unit 2080 may first searches the object relationship information 40 for a sequence of the action-related situations indicated by the event information 50 from which the lack situations are removed. Suppose that the event information 50 includes S[]={S[1],S[2], S[3]}, and S[2] is a lack situation. In this case, the determining unit 2080 first determines whether or not the object relationship information 40 includes a sequence of action-related relationships that matches {S[1],S[3]}, which is a sequence of the situations generated by removing S[2] from S[].

Then, for each one of the lack situations, the determining unit 2080 determines whether or not a partial sequence obtained from the object relationship information 40 includes a situation opposite to the lack situation. This partial sequence is a sequence of the action-related relationships from an action-related relationship next to one matching the previous situation of the lack situation to an action-related relationship previous to one matching the next situation of the lack situation. Suppose that: the event information 50 includes S[]={S[1], S[2], S[3]}; S[2] is a lack situation; and the action-related relationships R[3] and R[10] match the action-related situations S[1] and S[3], respectively. In this case, the partial sequence is {R[4], . . . , R[9]}: R[4] is next to R[3] that matches S[1] and R[9] is previous to R[10] that matches S[3].

The situation opposite to a lack situation is a situation in which the action specified by the lack situation is taken by the subject specified by the lack situation. For example, when a lack situation represents a situation of “Person 1 does not stand in front of Cashier 1 for at least 10 seconds”, the situation opposite to the lack situation is a situation of “Person 1 stands in front of Cashier 1 for at least 10 seconds”.

When it is determined that, for all the lack situations, the corresponding partial sequence does not include the situation opposite to the lack situation, the determining unit 2080 determines that the object relationship information 40 includes a sequence of the action-related relationships that matches the sequence of the action-related situations indicated by the event information 50. On the other hand, when it is determined that the partial sequence includes the situation opposite to the lack situation for at least one of the lack situations, the determining unit 2080 determines that the object relationship information 40 does not includes a sequence of the action-related relationships that matches the sequence of the action-related situations indicated by the event information 50.

Suppose that: the event information 50 includes S[]={S[1], S[2], S[3]}; S[2] is a lack situation; and the action-related relationships R[3] and R[10] are determined to match the action-related situations S[1] and S[3], respectively. In this case, the determining unit 2080 determines whether or not the sequence {R[4], . . . , R[9]} includes a situation opposite to S[2]. When it is determined that the sequence {R[4], . . . , R[9]} does not include the situation opposite to S[2], the determining unit 2080 determines that the object relationship information 40

includes the sequence {R[3], R[10]} that matches the sequence S[]. On the other hand, when it is determined that the sequence {R[4], . . . , R[9]} includes the situation opposite to S[2], the determining unit 2080 determines that the sequence {R[3], R[10]} does not match the sequence S[].

### Output of Result

The event detecting apparatus 2000 may output information (hereinafter, “output information”) that is related to a result of the determination performed by the determining unit 2080. When it is determined that the action-related event indicated by the event information 50 does not occur, the event detecting apparatus 2000 generates the output information indicating that the video data 10 does not include the action-related event indicated by the event information 50.

When it is determined that the action-related event indicated by the event information 50 occurs, the event detecting apparatus 2000 generates the output information including information about that event. For example, the output information indicates the name of the event detected and the sequence of the action-related relationships that is determined to match the sequence of the action-related situations indicated by the event information 50. The name of the event may be defined in the event information 50.

For each one of the action-related relationships being determined to match the sequence of the action-related situations indicated by the event information 50, the output information may include a sequence of video frames 20 (in other words, a short clip extracted from the video data 10) from which that action-related relationship is detected. Suppose that Baggage Theft is detected from the video data 10. In this case, the output information includes a first short clip in which the first person placing the baggage is captured, a second short clip in which the second person picking up the baggage is captured, and a third short clip in which the second person carrying the baggage is captured.

Each event may have one or more objects of interest. For example, when a criminal event is detected, the criminal is the object of interest. It is preferable that the output information indicates information about the criminal. The information about an object may include an image of the object and characteristics of the objects. The image of the object can be extracted from the video frame 20 from which that object is detected.

The characteristics of the object depend on the type of object. The characteristics of a person may include the age, the gender, and the characteristics of the outfit. The characteristics of baggage may include the color, the shape, and the brand.

There are various ways to output the output information. For example, the event detecting apparatus 2000 may put the output information into a storage unit. In another example, the event detecting apparatus 2000 may output the output information to a display device, thereby causing the display device to display the contents of the output information. In another example, the event detecting apparatus 2000 may send the output information to another apparatus, such as a mobile device carried around by a security guard or a PC used in a security room.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

An example advantage according to the above-described embodiments is that a novel technique to monitor objects based on a video data on which those objects are captured is provided.

The whole or part of the example embodiments disclosed above can be described as, but not limited to, the following supplementary notes.

### Supplementary Notes

### Supplementary Note 1

An event detecting apparatus comprising:

at least one memory that is configured to store instructions; and

at least one processor that is configured to execute the instructions to:

acquire one or more video data;

generate, from the one or more video data, object relationship information that indicates two or more action-related relationships between objects;

acquire an event information that indicates an event of interest by a sequence of action-related situations at least one of which represents a situation in which a specific action is taken by a specific subject; and

determine whether or not the event of interest occurs based on the object relationship information and the event information.

### Supplementary Note 2

The event detecting apparatus according to Supplementary note 1,

wherein it is determined that the event of interest occurs when the object relationship information includes a sequence of the action-related relationships that matches the sequence of the action-related situations indicated by the event information.

### Supplementary Note 3

The event detecting apparatus according to Supplementary note 2,

wherein the temporal action-related relationship indicates a combination of an action, a subject of the action, and an object of the action,

wherein the action-related situation indicates a combination of an action, a subject of the action, and an object of the action, and

wherein the temporal action-relate relationship is determined to match the action-related situation when the action, the subject of the action, and the object of the action indicated by the temporal action-related relationship respectively match the action, the subject of the action, and the object of the action indicated by the action-related situation.

### Supplementary Note 4

The event detecting apparatus according to Supplementary note 2 or 3,

wherein the event information includes a first action-related situation and a second action-related situation in this order, and

wherein it is determined that the event of interest occurs when the object relationship information includes a first action-related relationship matching the first action-related situation and a second action-related relationship matching the second action-related situation in this order.

### Supplementary Note 5

The event detecting apparatus according to Supplementary note 2 or 3,

wherein event information includes a first action-related situation, a second action-related situation, and a third action-related situation,

wherein each one of the first action-related situation and the third action-related situation represents a situation in which a specific action is taken by a specific subject,

wherein the second action-related situation represents a situation in which a specific action is not taken by a specific subject, and

wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

### Supplementary Note 6

The event detecting apparatus according to any one of Supplementary notes 1 to 3,

wherein the event information indicates two or more objects that are of a same type as each other and are different from each other in a distinguishable manner.

### Supplementary Note 7

The event detecting apparatus according to any one of Supplementary notes 1 to 3,

wherein the object relationship information represents a sequence of scene graphs each of which represents relationships between objects that exist at a time or during a period of time.

### Supplementary Note 8

An event detecting method comprising:

acquiring one or more video data;

generating, from the one or more video data, object relationship information that indicates two or more action-related relationships between objects;

acquiring an event information that indicates an event of interest by a sequence of action-related situations at least one of which represents a situation in which a specific action is taken by a specific subject; and

determining whether or not the event of interest occurs based on the object relationship information and the event information.

### Supplementary Note 9

The event detecting method according to Supplementary note 8,

wherein it is determined that the event of interest occurs when the object relationship information includes a sequence of the action-related relationships that matches the sequence of the action-related situations indicated by the event information.

### Supplementary Note 10

The event detecting method according to Supplementary note 9,

wherein the temporal action-related relationship indicates a combination of an action, a subject of the action, and an object of the action,

wherein the action-related situation indicates a combination of an action, a subject of the action, and an object of the action, and

wherein the temporal action-relate relationship is determined to match the action-related situation when the action, the subject of the action, and the object of the action indicated by the temporal action-related relationship respectively match the action, the subject of the action, and the object of the action indicated by the action-related situation.

### Supplementary Note 11

The event detecting method according to Supplementary note 9 or 10,

wherein the event information includes a first action-related situation and a second action-related situation in this order, and

wherein it is determined that the event of interest occurs when the object relationship information includes a first action-related relationship matching the first action-related situation and a second action-related relationship matching the second action-related situation in this order.

### Supplementary Note 12

The event detecting method according to Supplementary note 9 or 10,

wherein event information includes a first action-related situation, a second action-related situation, and a third action-related situation,

wherein each one of the first action-related situation and the third action-related situation represents a situation in which a specific action is taken by a specific subject,

wherein the second action-related situation represents a situation in which a specific action is not taken by a specific subject, and

wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

### Supplementary Note 13

The event detecting method according to any one of Supplementary notes 8 to 10,

wherein the event information indicates two or more objects that are of a same type as each other and are different from each other in a distinguishable manner.

### Supplementary Note 14

The event detecting method according to any one of Supplementary notes 8 to 10,

wherein the object relationship information represents a sequence of scene graphs each of which represents relationships between objects that exist at a time or during a period of time.

### Supplementary Note 15

A storage medium storing a program that causes a computer to execute:

acquiring one or more video data;

generating, from the one or more video data, object relationship information that indicates two or more action-related relationships between objects;

acquiring an event information that indicates an event of interest by a sequence of action-related situations at least one of which represents a situation in which a specific action is taken by a specific subject; and

determining whether or not the event of interest occurs based on the object relationship information and the event information.

### Supplementary Note 16

The storage medium according to Supplementary note 15,

wherein it is determined that the event of interest occurs when the object relationship information includes a sequence of the action-related relationships that matches the sequence of the action-related situations indicated by the event information.

### Supplementary Note 17

The storage medium according to Supplementary note 16,

wherein the temporal action-related relationship indicates a combination of an action, a subject of the action, and an object of the action,

wherein the action-related situation indicates a combination of an action, a subject of the action, and an object of the action, and

wherein the temporal action-relate relationship is determined to match the action-related situation when the action, the subject of the action, and the object of the action indicated by the temporal action-related relationship respectively match the action, the subject of the action, and the object of the action indicated by the action-related situation.

### Supplementary Note 18

The storage medium according to Supplementary note 16 or 17,

wherein the event information includes a first action-related situation and a second action-related situation in this order, and wherein it is determined that the event of interest occurs when the object

relationship information includes a first action-related relationship matching the first action-related situation and a second action-related relationship matching the second action-related situation in this order.

### Supplementary Note 19

The storage medium according to Supplementary note 16 or 17,

wherein event information includes a first action-related situation, a second action-related situation, and a third action-related situation,

wherein each one of the first action-related situation and the third action-related situation represents a situation in which a specific action is taken by a specific subject,

wherein the second action-related situation represents a situation in which a specific action is not taken by a specific subject, and

wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

What is claimed is:

1. An event detecting apparatus comprising:
at least one memory that is configured to store instructions; and
at least one processor that is configured to execute the instructions to:
acquire one or more video data;
generate, from the one or more video data, object relationship information that indicates two or more action-related relationships between objects;
acquire an event information that indicates an event of interest by a sequence of action-related situations at least one of which represents a situation in which a specific action is taken by a specific subject; and
determine whether or not the event of interest occurs based on the object relationship information and the event information.

2. The event detecting apparatus according to claim 1,
wherein it is determined that the event of interest occurs when the object relationship information includes a sequence of the action-related relationships that matches the sequence of the action-related situations indicated by the event information.

3. The event detecting apparatus according to claim 2,
wherein the temporal action-related relationship indicates a combination of an action, a subject of the action, and an object of the action,
wherein the action-related situation indicates a combination of an action, a subject of the action, and an object of the action, and
wherein the temporal action-relate relationship is determined to match the action-related situation when the action, the subject of the action, and the object of the action indicated by the temporal action-related relationship respectively match the action, the subject of the action, and the object of the action indicated by the action-related situation.

4. The event detecting apparatus according to claim 2,
wherein the event information includes a first action-related situation and a second action-related situation in this order, and
wherein it is determined that the event of interest occurs when the object relationship information includes a first action-related relationship matching the first action-related situation and a second action-related relationship matching the second action-related situation in this order.

5. The event detecting apparatus according to claim 2,
wherein event information includes a first action-related situation, a second action-related situation, and a third action-related situation,
wherein each one of the first action-related situation and the third action-related situation represents a situation in which a specific action is taken by a specific subject,
wherein the second action-related situation represents a situation in which a specific action is not taken by a specific subject, and
wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

6. The event detecting apparatus according to claim 1,
wherein the event information indicates two or more objects that are of a same type as each other and are different from each other in a distinguishable manner.

7. The event detecting apparatus according to claims 1,
wherein the object relationship information represents a sequence of scene graphs each of which represents relationships between objects that exist at a time or during a period of time.

8. An event detecting method comprising:
acquiring one or more video data;
generating, from the one or more video data, object relationship information that indicates two or more action-related relationships between objects;
acquiring an event information that indicates an event of interest by a sequence of action-related situations at least one of which represents a situation in which a specific action is taken by a specific subject; and
determining whether or not the event of interest occurs based on the object relationship information and the event information.

9. The event detecting method according to claim 8,
wherein it is determined that the event of interest occurs when the object relationship information includes a sequence of the action-related relationships that matches the sequence of the action-related situations indicated by the event information.

10. The event detecting method according to claim 9,
wherein the temporal action-related relationship indicates a combination of an action, a subject of the action, and an object of the action,
wherein the action-related situation indicates a combination of an action, a subject of the action, and an object of the action, and
wherein the temporal action-relate relationship is determined to match the action-related situation when the action, the subject of the action, and the object of the action indicated by the temporal action-related relationship respectively match the action, the subject of the action, and the object of the action indicated by the action-related situation.

11. The event detecting method according to claim 9,
wherein the event information includes a first action-related situation and a second action-related situation in this order, and
wherein it is determined that the event of interest occurs when the object relationship information includes a first action-related relationship matching the first action-related situation and a second action-related relationship matching the second action-related situation in this order.

12. The event detecting method according to claim 9,
wherein event information includes a first action-related situation, a second action-related situation, and a third action-related situation,
wherein each one of the first action-related situation and the third action-related situation represents a situation in which a specific action is taken by a specific subject,
wherein the second action-related situation represents a situation in which a specific action is not taken by a specific subject, and
wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

13. The event detecting method according to claim 8,
wherein the event information indicates two or more objects that are of a same type as each other and are different from each other in a distinguishable manner.

14. The event detecting method according to claim 8,
wherein the object relationship information represents a sequence of scene graphs each of which represents relationships between objects that exist at a time or during a period of time.

15. A non-transitory computer-readable storage medium storing a program that causes a computer to execute:
acquiring one or more video data;
generating, from the one or more video data, object relationship information that indicates two or more action-related relationships between objects;
acquiring an event information that indicates an event of interest by a sequence of action-related situations at least one of which represents a situation in which a specific action is taken by a specific subject; and
determining whether or not the event of interest occurs based on the object relationship information and the event information.

16. The storage medium according to claim 15,
wherein it is determined that the event of interest occurs when the object relationship information includes a sequence of the action-related relationships that matches the sequence of the action-related situations indicated by the event information.

17. The storage medium according to claim 16,
wherein the temporal action-related relationship indicates a combination of an action, a subject of the action, and an object of the action,
wherein the action-related situation indicates a combination of an action, a subject of the action, and an object of the action, and
wherein the temporal action-relate relationship is determined to match the action-related situation when the action, the subject of the action, and the object of the action indicated by the temporal action-related relationship respectively match the action, the subject of the action, and the object of the action indicated by the action-related situation.

18. The storage medium according to claim 16,
wherein the event information includes a first action-related situation and a second action-related situation in this order, and
wherein it is determined that the event of interest occurs when the object relationship information includes a first action-related relationship matching the first action-related situation and a second action-related relationship matching the second action-related situation in this order.

19. The storage medium according to claim 16,
wherein event information includes a first action-related situation, a second action-related situation, and a third action-related situation,
wherein each one of the first action-related situation and the third action-related situation represents a situation in which a specific action is taken by a specific subject,
wherein the second action-related situation represents a situation in which a specific action is not taken by a specific subject, and
wherein it is determined that the event of interest occurs when the object relationship information includes a first action-related relationship matching the first action-related situation and a second action-related relationship matching the second action-related situation in this order and when the object relationship information includes no action-related relationship that matches an action-related situation opposite to the second action-related situation.

20. The storage medium according to claim 15,
wherein the event information indicates two or more objects that are of a same type as each other and are different from each other in a distinguishable manner.
